(19) United States
(12) Patent Application Publication
(10) Pub. No.: US 2017/0351643 A1
(43) Pub. Date: Dec. 7, 2017

(54) SYSTEM FOR AUTOMATICALLY DISPLAYING PAGES OF A DIGITAL EDITION AND COMPUTER IMPLEMENTED METHOD FOR SAME

(71) Applicant: NUGLIF INC., Montréal (CA)

(72) Inventors: Charle DEMERS, Montréal (CA); Anis BEREJEB, Laval (CA)

(21) Appl. No.: 15/521,182

(22) PCT Filed: Nov. 20, 2014
(86) PCT No.: PCT/CA2014/051108

§ 371 Date: Apr. 21, 2017

(51) Int. Cl. G06F 17/21; G06F 17/24; G06F 17/22

(52) U.S. Cl. CPC G06F 17/212; G06F 17/2247; G06F 17/24

(57) ABSTRACT

A system for automatically displaying pages of a digital edition while at least some of the pages are concurrently being edited on an editing system. The system comprises processor-based devices, each requesting an update of a page and maintaining a communication channel open between the processor-based device and a storage unit, an assembler unit continually generating updated compiled files of the edited pages and continually sending the updated compiled files to the storage unit storing the updated compiled files and sending, over the communication channel established with one of the processor-based devices, the updated compiled file corresponding to the page for which the processor-based devices has requested an update, as the updated compiled file is received on the storage unit. A computer implemented method for performing the same is also provided.

### TECHNICAL FIELD OF THE INVENTION

The present invention relates to the field of digital editions. More particularly, it relates to a system for automatically displaying pages of a digital edition on at least one processor-based device while at least some of the pages are concurrently being edited on computers connected to an editing system. The invention also relates to a computer implemented method for performing the same.

### BACKGROUND

In the field of digital publication production, especially in the context of digital periodical publications, such as newspapers and magazines, collaborative work of a group of users (or computer operators) is often required. Such collaborative work requires the different users to concurrently edit pages of an edition of the digital periodical publication, and display the output of the edited pages on processor-based devices in order to confirm that the output displayed on the processor-based devices is satisfactory. The users are thus working on different pages of the digital edition using different computers connected to a main editing system. Since digital publications are typically adapted to a specific type of processor-based devices, for example iPads™, Samsung Galaxy™ tablets, or the like, the users must subsequently download and display the pages of the digital edition on the processor-based devices to make sure that the page layout designed on the display screen of their computers, using the editing system, renders correctly on the display screen of the processor-based devices.

In order to allow displaying of pages of the digital edition on the processor-based devices, it is generally required to compile the edition. A system and a method which allow users to concurrently display pages by compiling an entire edition while some of the pages are being edited by other users is described in the Applicant's International Patent Application no. WO2014107808.

However, the compilation of an entire digital edition in order to display edited pages on processor-based devices can be both resource-intensive and time consuming for the users. This is undesirable, for instance and without being limitative in peak periods, such as close to the publication deadline, during which a large number of users wish to preview the page(s) that they have edited in order to validate their work before the publication of the digital edition. Existing solutions do not allow displaying the layout of the pages of an edition on different types of processor-based devices in a timely manner.

In view of the above, there is a need for an improved system and method for automatically displaying edited pages of a digital edition on processor-based devices, which would be able to overcome or at least minimize some of the drawbacks discussed above. It would also be desirable to be able to display the pages on different types of processor-based devices.

### BRIEF SUMMARY OF THE INVENTION

According to a first general aspect, there is provided a system for automatically displaying pages of a digital edition while at least some of the pages are concurrently being edited on computers connected to an editing system. The system comprises processor-based devices, each having a communication module configured to request an update of a given page of the digital edition and to maintain a page communication channel open between the corresponding one of the processor-based devices and a storage unit. Each one of the processor-based devices also has a display for displaying the update of the given page upon receiving an updated compiled file for the given page. The system also comprises an assembler unit operatively connected to the editing system. The assembler unit comprises a compiler module configured to continually generate updated compiled files of edited pages of the digital edition, as they are being edited on the computers connected to the editing system. The assembler unit also comprises an output to continually send the updated compiled files to the storage unit. The system further comprises a storage unit operatively connected to the processor-based devices and to the assembler unit. The storage unit has a memory configured to store the updated compiled files and a communication module configured to send, over the page communication channel established with a given one of the processor-based devices, the updated compiled file corresponding to the given page for which the given one of the processor-based devices has requested an update, as the updated compiled file is being received on the storage unit.

In an embodiment, the compiler module is configured to continually generate updated compiled files of at least edited pages of the digital edition for which an update has been requested by one of the processor-based devices, as they are being edited on the computers connected to the editing system.

In an embodiment, for each one of the processor-based devices, the communication module is configured to repetitively re-establish the page communication channel with the storage unit upon closure of the page communication channel.

In an embodiment, the processor-based devices and the storage unit comprise a mechanism for establishing the page communication channel and sending the updated compiled file. The mechanism includes one of a network socket mechanism, a websocket mechanism and an HTTP long poll mechanism.

In an embodiment, the compiler module comprises a parser configured to determine whether the edited pages are error-free or error-generating pages and the compiler module generates error-specific updated compiled files if the edited pages are error-generating pages.

In an embodiment, the system further comprises a page update database connected to the assembler unit. The page update database is configured to store a new compilation request including page identification data and a compilation status for each of the edited pages.

In an embodiment, the assembler unit is in communication with the page update database and is configured to, for each successive compilation request, fetch page data relating to the edited page corresponding to the identification data stored in the compilation request, compile the page data of the corresponding edited page through the compiler module, and delete the compilation request.

In an embodiment, the assembler unit is configured to store a new compilation request in the page update database for one of the edited pages if no compilation request containing page identification relating to the page is already stored in the page update database.

In an embodiment, the assembler unit is further configured to receive messages indicative that one of the pages of the edition has been edited on the editing system.

In an embodiment, the processor-based devices each have a respective memory, and for each one of the processor-based devices, the memory is configured to store assets associated with the given page, and the communication module is configured to request, from the storage unit, assets associated with the updated compiled file for the given page which are not stored in its memory.

In an embodiment, the communication module of each one of the processor-based devices is configured to send a request for each one of the assets associated with the updated compiled file for the given page which is not stored in its memory and to maintain an asset communication channel open during a maximum of a predetermined time interval to receive a corresponding one of the assets when it is available from the storage unit.

According to another general aspect, there is also provided a computer implemented method for automatically displaying pages of a compiled digital edition on processor-based devices, while at least some of the pages are concurrently being edited on computers connected to an editing system. The method comprises the steps of:
a) requesting, by at least a given one of the processor-based devices, an update for a given page of the digital edition and maintaining a page communication channel open between at least the given one of the processor-based devices and a storage unit;
b) continually generating, on an assembler unit, updated compiled files of pages of the edition being edited on the computers connected to the editing system and continually sending the updated compiled files for storing on the storage unit;
c) sending, by the storage unit, over the page communication channel, the updated compiled file corresponding to the given page for which the given one of the processor-based devices has requested an update as the updated compiled file is being received on the storage unit; and
d) displaying the update of the given page on the given one of the processor-based devices.

In an embodiment, step b) comprises continually generating, on the assembler unit, updated compiled files of at least pages of the edition being edited on the computers connected to the editing system and for which an update has been requested by at least one of the processor-based devices.

In an embodiment, step a) is continually repeated upon closure of the page communication channel.

In an embodiment, step b) comprises receiving a message from the editing system indicating that the page has been edited.

In an embodiment, the method comprises a step performed prior to step a), of requesting by the given one of the processor-based devices a compiled file of the given page, storing the compiled file on the given one of the processor-based devices and displaying the page.

In an embodiment, steps a) and c) are performed using one of a network socket mechanism, a websocket mechanism and an HTTP long poll mechanism.

In an embodiment, step b) further comprises the step of, for each one of at least the pages of the edition being edited on the computers connected to the editing system, determining whether the page is an error-free or an error-generating page and generating an error-specific compiled file if the page is an error-generating page.

In an embodiment, step b) comprises scheduling a compilation of one of the edited pages only if a compilation of the page has not already been scheduled.

In an embodiment, the method comprises a step of downloading from the storage unit, by the given one of the processor-based devices, assets associated with the updated compiled file corresponding to the given page of the digital edition which are not already stored in a memory of the given one of the processor-based devices.

In an embodiment, the step of downloading assets comprises maintaining an asset communication channel open during a maximum of a predetermined time interval, to receive a corresponding one of the assets when it is available from the storage unit.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a schematic block diagram of a system for automatically displaying pages of a digital edition on at least one processor-based device while at least some of the pages are concurrently being edited on computers connected to an editing system, according to a possible embodiment of the invention.

FIGS. 2a and 2b are respectively a schematic representation of the processing device displaying a page of the edition and a schematic representation of compiled files, each corresponding to a page of the edition, according to an exemplary embodiment.

FIG. 3 is a schematic representation of the assembler unit of the system shown in FIG. 1, according to an exemplary embodiment.

FIG. 4 is a schematic representation of the storage module of the system shown in FIG. 1, according to an exemplary embodiment.

FIG. 5 is a schematic representation of one of the processor-based device of the system shown in FIG. 1, according to an exemplary embodiment.

FIG. 6 is a sequence diagram of a sequence of operation between the editing of a page on the editing system and the transmission of an updated compiled file for the page to the storage unit, according to an exemplary embodiment.

FIG. 7 is a sequence diagram of a sequence of operation for the transmission of updated compiled files from the storage unit to one of the processor-based device, according to an exemplary embodiment.

FIG. 8 is a sequence diagram of a sequence of operation for the transmission of an asset from the storage unit to one of the processor-based device, according to an exemplary embodiment.

FIG. 9 is a flow chart illustrating a method for automatically displaying pages of a digital edition on at least one processor-based device while at least some of the pages are concurrently being edited on computers connected to an editing system, according to an exemplary embodiment.

FIG. 10 is a flow chart illustrating steps for transmitting assets to the processor-based device, according to an exemplary embodiment.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the system for automatically displaying edited pages of a digital edition on a processor-based device consist of certain components and although the associated method includes steps as explained and illustrated herein, not all of these components, configurations and steps are essential and thus should not be taken in their restrictive sense. It is to be understood, as also apparent to a person skilled in the art, that other suitable components and cooperation thereinbetween, as well as other suitable configurations, organizations and/or architectures may be used for the system and method for automatically displaying edited pages of a digital edition on a portable device, as will be briefly explained herein and as can be easily inferred herefrom by a person skilled in the art.

Broadly described, the system and method are designed to automatically compile a page (or a portion thereof) part of a digital edition. The compilation can occur while or after the page is being edited on a computer connected to an editing system. The system is configured to generate an updated compiled file and to transfer the updated compiled file to a processor-based device. The processor-based device is distinct from the computer on which the page is being edited. The system and method allow at least one user to edit a page of a digital edition on an editing system and to display a compiled version of the page on at least one processor-based device, without having to manually request the compilation of the page and without having to compile the entire digital edition. Different users can edit different pages of the same edition concurrently, and the system allows these users, to individually display the page they are editing while they are editing the page on the computer connected to the editing system. In an embodiment the system and method allow the pages to be displayed simultaneously or concurrently on different types of processor based devices (which may have different characteristics), in order to validate that the display is satisfactory (or renders correctly) on each one of the processor based devices. The different types of processor based devices can be, for example and without being limitative, iPads™, Samsung Galaxy™ tablets, or the like, which have different display screen sizes, different operating systems, etc.

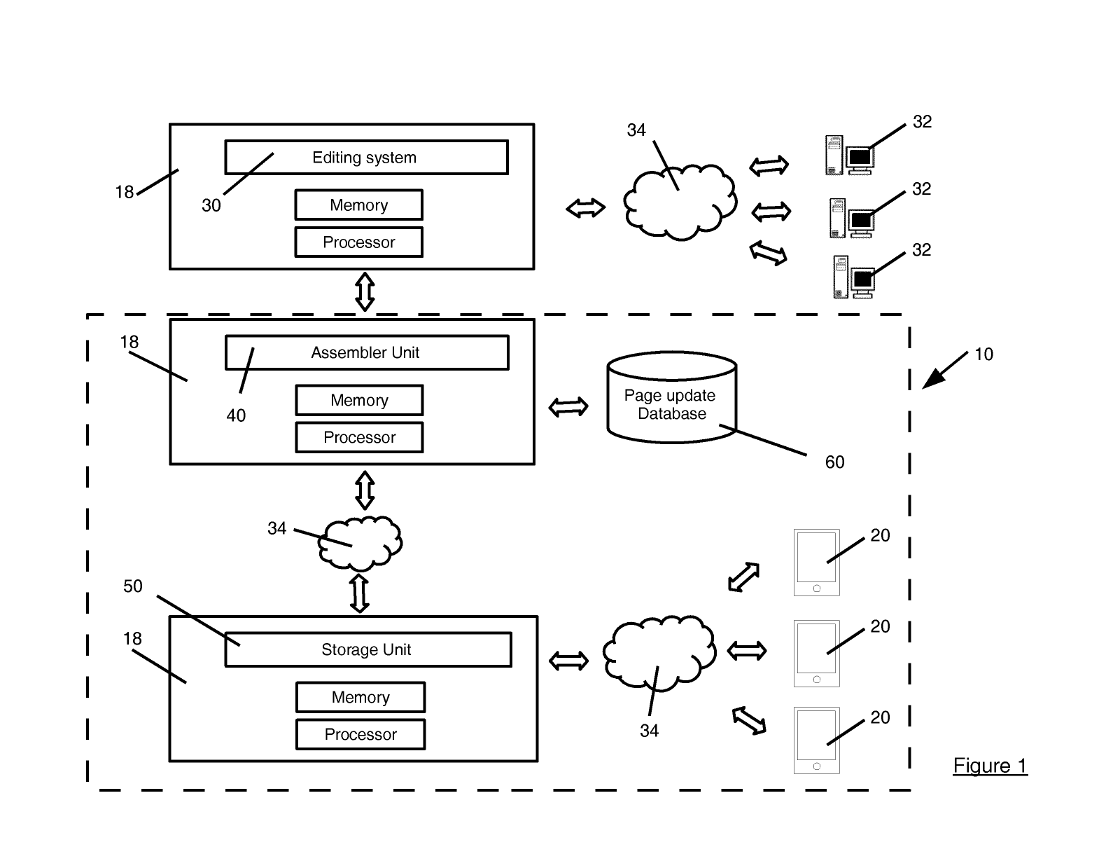

Referring generally to FIG. 1, an embodiment of a system 10 is shown. The system 10 allows the automatic display of pages of a digital edition on processor-based devices 20. The system 10 includes an assembler unit 40, a storage unit 50 and several processor-based devices 20. The system 10 cooperates with an editing system 30. In some embodiments, the system 10 can include the editing system 30.

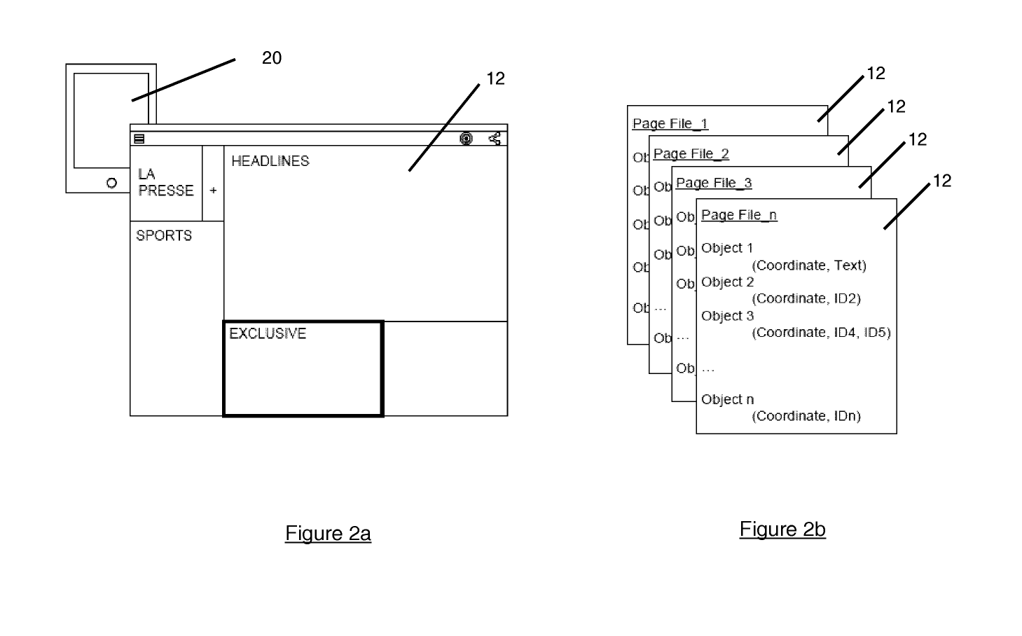

Throughout the present description, and referring to FIGS. 2a and 2b, the term “page” 12 refers to a specific combination of content, arranged according to a specific layout, on a single digital sheet to be displayed on the screen of a processor-based device 20. A “page” 12 can include text, but also other types of content or objects such as images, graphics, interactive objects or animations, advertisements, videos, web links, charts, timelines, and the like, and which are referred to herein as “assets”. In an embodiment, a page 12 can also include sub-pages integrated therein, each one of the sub-pages including the same type of content or objects as a page 12, as described above.

The term “page data” is used in the present document to refer to the data representative of the pages of an edition which are edited by users through the editing system, i.e. prior to the compilation. The “page data” includes information relating to the layout of a corresponding one of the pages 12, such as, and without being limited to, the position of text or assets on the page. The terms “compiled file” and “updated compiled file” refer to files resulting from the compilation of the page data of a page in a compiled format. The term “compiled page” is used to refer to any version of a compilation of the page data, while the term “updated compiled page” refers to a version of a compilation of the page data resulting from the page being edited by a user on the editing system. The term “edition” is used to define a collection of pages, arranged according to a specific order or arrangement.

In an embodiment, the page data can also relate to only a portion (or fragment) of a page 12 which has been edited by users through the editing system. In such an embodiment, the terms “compiled file” and “updated compiled file” can refer to files resulting from the compilation of the page data representing only the edited portion (or fragment) of the page, in a compiled format. One skilled in the art will understand that, in such an embodiment, the compiled version of the page displayed on the processor based device includes a combination of the compiled file of a previous version of the page and the updated compiled file corresponding to the portion of the page edited through the editing system and subsequently compiled. The term “compilation of the page data” is used herein to refer to the process of converting page data from the editing system into a format suitable for transmission to a processor-based device and for subsequent display of the page on the screen of the processor-based device. The page is displayed on the processor-based device using a display module and a dedicated software application running on the processor-based device.

In an embodiment, the page data is compiled in a lightweight data-interchange format, such as, for example and without being limited to, a JavaScript Object Notation (JSON) format. One skilled in the art will understand that, in an alternative embodiment, other types of formats having similar characteristics to the JSON format can also be used, such as, for example, XML (Extensible Markup Language) format. One skilled in the art will also understand that the compiled pages generated during the compilation of the page data can be platform independent, i.e. the same file can be used for various processor-based devices running a different operating system or having a different hardware configuration, provided that a dedicated software application configured to read the compiled pages is installed thereon. In yet other embodiments, the compiled file of the page is adapted to a specific processor-based device. FIG. 2b shows an exemplary embodiment of a plurality of compiled files corresponding to pages 12 of the digital edition.

The term “processor-based device” is used herein to refer to an electronic device such as, and without being limited to, electronic tablets, smartphones, laptops, desktop computers or the like. One skilled in the art will understand that the term “processor-based device” can be used interchangeably with terms such as “data processing device” and “communication device”. Each processor-based device comprises a display screen, a processor, a memory and communication ports.

The term “display”, is used herein to refer to either the preview of a page by users working on the edition, during the creation process of the edition, or the publishing of the compiled file on the display screen of the processor-based devices of end-users.

The term “dedicated software application” is used herein to refer to an application stored in the memory of the processor-based device, and which is configured to read files in a format specifically designed for use with said application.

The term “memory” is used to refer generally to any tangible computer-readable medium including, for example and without being limited to, persistent memory such as magnetic and/or optical disks, ROM, and PROM and volatile memory such as RAM.

Turning back to FIG. 1, the editing system 30 is, in general terms, a collaborative platform allowing several users to edit pages of a digital edition. The use of the editing system 30 allows users to create and/or modify the content and/or layout of pages of the digital edition. The assembler unit 40 is the unit which receives page data from the editing system 30, compiles the page data of the different pages of the digital edition, and handles errors. In an embodiment, the assembler unit 40 generates updated compiled files for the pages edited through the editing system 30 to allow the pages to be displayed on the processor-based devices 20. In another possible embodiment, the assembler unit 40 may solely compile pages of the edition which are being edited and for which there is a request to display the changes on a processor-based device 20. The storage unit 50 is a unit which stores the updated compiled files of the pages to be displayed on the processor-based devices 20. It is also configured to transfer a given updated compiled file to one of the processor-based devices 20 which requested the latest version of the page. In an embodiment, and as will be described in more detail below, the storage unit 50 also stores the assets associated to the compiled pages. The storage unit 50 is configured to transfer a given asset to the processor-based device 20 which requested the asset.

In an embodiment, the editing system 30, the assembler unit 40 and the storage unit 50 are part of a distributed computing system, i.e. they are installed on separate computing units 18 having their own memory and processor. One skilled in the art would understand that, in another embodiment (not shown), the editing system 30, the assembler unit 40 and/or the storage unit 50 can also be centralized on a single computing unit 18. Moreover, in yet another embodiment (not shown), the editing system 30, the assembler unit 40 and the storage unit 50 can each include a plurality of components distributed on separate computing units 18, the components cooperating with one another to operate as a unified editing system 30, assembler unit 40 and/or storage unit 50. In an embodiment, the editing system 30, the assembler unit 40 and/or the storage unit 50 can communicate through, for example and without being limitative, web services, low level custom network socket protocols, high level standardized SOAP services, or the like, such that the systems are communicatively coupled while remaining format independent, thereby resulting in more flexibility in the development of the system/units 30, 40, 50.

As mentioned above, the editing system 30 allows users to edit the content and/or the layout of the pages of an edition, i.e. users can add, delete or modify the content of the pages and/or can edit the layout of the content on the page to define how the content is to be displayed on the processor-based devices 20. In an embodiment, in order to allow collaborative editing of the pages of the edition by multiple users, the editing system 30 can be accessed concurrently by a plurality of computers (or remote terminals) 32 communicating with the editing system 30 over a network 34, such as, for example and without being limited to, a local area network (LAN) or a wide area network (WAN). Hence, a plurality of users can simultaneously edit the pages of an edition. Different pages of the same edition can thus be edited simultaneously, or the same page can be edited simultaneously by more than one user.

The editing system 30 provides users with different tools to populate pages with text, titles, images, graphics, interactive objects or animations, advertisements, videos, web links, charts, timelines, and other similar assets. These tools can be accessed through a user interface (or GUI) displayed on the screen of one of the plurality of computers 32 connected to the editing system 30, using input means such as a keyboard and/or a mouse.

As mentioned above, data relating to pages or portions of pages of an edition which is generated by the editing system 30 is referred to as “page data”. In an embodiment, the page data is stored in the memory of the computing unit 18 hosting the editing system 30.

Referring to FIGS. 1 and 3, the assembler unit 40 is operatively connected to the editing system 30, such that the assembler unit 40 and the editing system 30 communicate with one another. In an embodiment, the assembler unit 40 includes an input module 42 which receives data from the editing system 30, a compiler module 44 which compiles the page data in an updated compiled file for each page of the digital edition for which the page data is compiled, and an output module 48 which sends the updated compiled files to the storage unit 50.

In an embodiment, the input module 42 receives messages indicative that pages of the edition have been edited on the editing system 30. For example, the input module 42 can listen to requests from the editing system 30 and intercept messages which indicate that pages of the edition have been edited on the editing system 30 (i.e. pull information from the editing system 30). One skilled in the art will understand that, in an alternative embodiment, the editing system 30 can also send a notification to the input module 42 each time one of the pages of the edition is edited on the editing system 30 (i.e. push information to the assembler unit 40).

In an embodiment, the compiler module 44 sequentially compiles the page data of each page edited on the editing system 30. The assembler unit 40 is connected to a page update database 60 configured to store new compilation requests which correspond to pages scheduled for subsequent compilation by the compiler module 44. In an embodiment, a new compilation request is stored each time the input module 42 receives a message indicative that a page has been edited on the editing system 30. In an alternative embodiment, as will be described in more details below, a new compilation request can rather be stored only when a message indicating that a page has been edited on the editing system 30 is received by the input module 42 and when an update has also been requested by one of the processor-based devices 20 for this page. It will be understood that, in an embodiment, the page update database 60 can also be part of the assembler system 40.

Each new compilation request stored in the page update database 60 includes at least page identification data (i.e. an identifier of the page) and a compilation status. In an embodiment, the compilation status can be one of “waiting”, indicative that the page is waiting to be compiled, or “compiling”, indicative that the page is currently being compiled. One skilled in the art will understand that the compilation status of each compilation request must be updated in order to accurately reflect the status of the page in real-time. As such, the status of a page is initially “waiting” and is updated to “compiling” once the compilation of the page begins. One skilled in the art will also understand that, in an embodiment, the status can be represented by binary data or the like.

One skilled in the art will understand that, in an embodiment, the page update database 60 (or any other database referred to in the present description), can be a subset of a larger database of the system 10, i.e. it can encompass only some of the tables of a larger database used by the system 10. Moreover, one skilled in the art will understand that, even though the term “database” is used herein to represent the data collection tool, in alternative embodiments different types of data collection allowing inputting, storing, retrieving and managing of data, such as for example and without being limitative, text documents, binary files, or the like, can be used.

In an embodiment, in order to perform the sequential compilation of page data, the input module 42 successively fetches page data from the editing system 30 for each compilation request. Page data is fetched for the page associated with the identification data stored in the corresponding compilation request. One skilled in the art will understand that, in an alternative embodiment, instead of the input module 42 pulling (fetching) the page data from the editing system 30, the page data can rather be pushed by the editing system 30 to the input module 42.

After the page data is retrieved from the editing system 30, the page data is compiled by the compiler module 44 to generate an updated compiled file for the specific page. When the compilation of the page data starts, the compilation status of the corresponding compilation request in the page update database 60 is updated from “waiting” to “compiling”. When the compilation is complete, the corresponding compilation request in the page update database 60 is deleted from the page update database 60 and the generated updated compiled file is sent to the storage unit 50 by the output module 48. Hence, as the compilation process is performed, the output module 48 continually sends updated compiled files to the storage unit 50.

In an embodiment, the compiler module 44 includes a parser 46. Before compiling the page data of a specific page, the parser 46 determines whether the page data will generate an error during compilation. The page is therefore classified as an error-free page or an error-generating page. If the page is an error-free page, no action is taken by the parser 46 and the compiler module 44 proceeds with the compilation of the page data. In an embodiment, if the page is an error-generating page, the parser 46 generates replacement page data for that particular page. The replacement page data corresponds to page data of a non-error generating page, and indicates the cause of the error which prevented the normal compilation of the page. The compiler module 44 compiles the replacement page data and generates an error-specific updated compiled file, with the compiled file indicating the error type and/or cause. In an embodiment, the replacement page data can also be page data with pre-defined text indicating that the page generated an error during the parsing process. In an alternative embodiment, the compiler module 44 can use a pre-existing error-specific updated compiled file directly. The pre-existing file is stored in a memory of the assembler unit 40, and indicates the error type and/or cause. It will be understood that the term “error” is used herein to refer to non-fatal errors which do not cause a system crash or failure. In an embodiment, the replacement page data for known possible errors are stored in the memory of the computing unit 18 hosting the assembler system 40.

In order to prevent duplicate compilations, in an embodiment, the assembler unit 40 is configured such that it does not create a new compilation request in the page update database 60 for an edited page, if a compilation request for that page is already stored in the page update database 60 and the status of this compilation request is set to “waiting”. However, if there is a compilation request stored in the in the page update database 60 for an edited page, and the status of this compilation request is set to “compiling”, a new compilation request for that specific page is created and stored, as long as there is no additional compilation request for the same page stored in the page update database 60. In this scenario, the edited page is more recent than the version currently being compiled, and a new compilation is therefore necessary to include the latest edits in an updated compiled file.

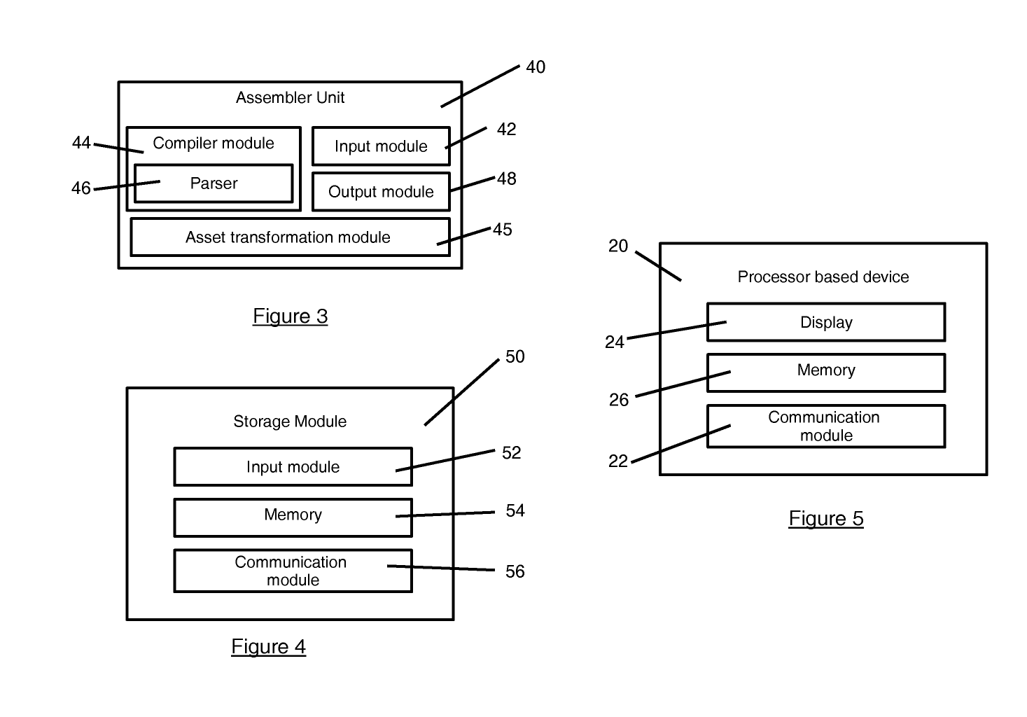

Referring to FIGS. 1 and 4, the storage unit 50 is in communication with the assembler system 40 and the at least one processor-based device 20. The communication can occur over a network 34, such as and without being limited to, a local area network (LAN) or a wide area network (WAN). In an embodiment, the storage unit 50 is a computer, such as a dedicated server, or the like, but one skilled in the art will understand that, in an alternative embodiment the storage unit 50 could be any type of computer or computer module capable of storing files and communicating with the assembler system 40 and the at least one processor-based device 20.

In an embodiment, the storage unit 50 includes an input module 52 for receiving updated compiled files from the assembler unit's 40 output module 48 and a memory 54 for storing the updated compiled files. The storage unit 50 further includes a communication module 56 configured to manage communications with the at least one processor-based device 20. The communication module 56 transfers updated compiled files as they are received on the storage unit 50. Each compiled file transferred in this manner corresponds to a page requested by one of the processor-based devices 20.

Referring to FIG. 6, a sequence of operation for compiling a page edited by a user, according to an exemplary embodiment, is shown. The page is edited by the user on a computer 32 connected to the editing system 30, and associated updated compiled file is transmitted to the storage unit 50. One skilled in the art will understand that, in an embodiment, such a sequence of operation is performed simultaneously for a plurality of pages being edited by multiple users and/or that multiple users can edit the same page in order to trigger the above described sequence of operation.

In FIG. 6, at step 601, a page 0x01 is edited by a user on a computer 32 connected to the editing system 30 and the changes are saved. At step 602, a message indicative that page 0x01 has been edited is sent to the input module of the assembler unit 40. At steps 603, 604 and 605 the assembler unit 40 verifies whether a compilation request for page 0x01 is stored in the page update database 60 and, in the negative, stores a compilation request for page 0x01 in the page update database 60. In the illustrated case, a compilation request for page 0x01 is stored in the page update database 60 (step 605) because no corresponding compilation request already exists in the page update database 60. The assembler unit 40 subsequently scrolls the page update database 60 sequentially and compiles each page associated with a compilation request. At steps 606 and 607, upon reaching the specific compilation request of page 0x01, the assembler unit 40 retrieves the page identification data for page 0x01 from the page update database 60 (step 606) and fetches the page data related to page 0x01 from the editing system 30 (step 607). At step 608, the parser of the compiler module of the assembler unit 40 determines whether the page data fetched from the editing system 30 is error-free. In this case, page 0x01 is error free, so the compiler module of the assembler unit 40 compiles the page data and generates an updated compiled file for page 0x01 at step 609. At step 610, the generated updated compiled file is transmitted by the output module of the assembler unit 40 to the input module 42 of the storage unit 50.

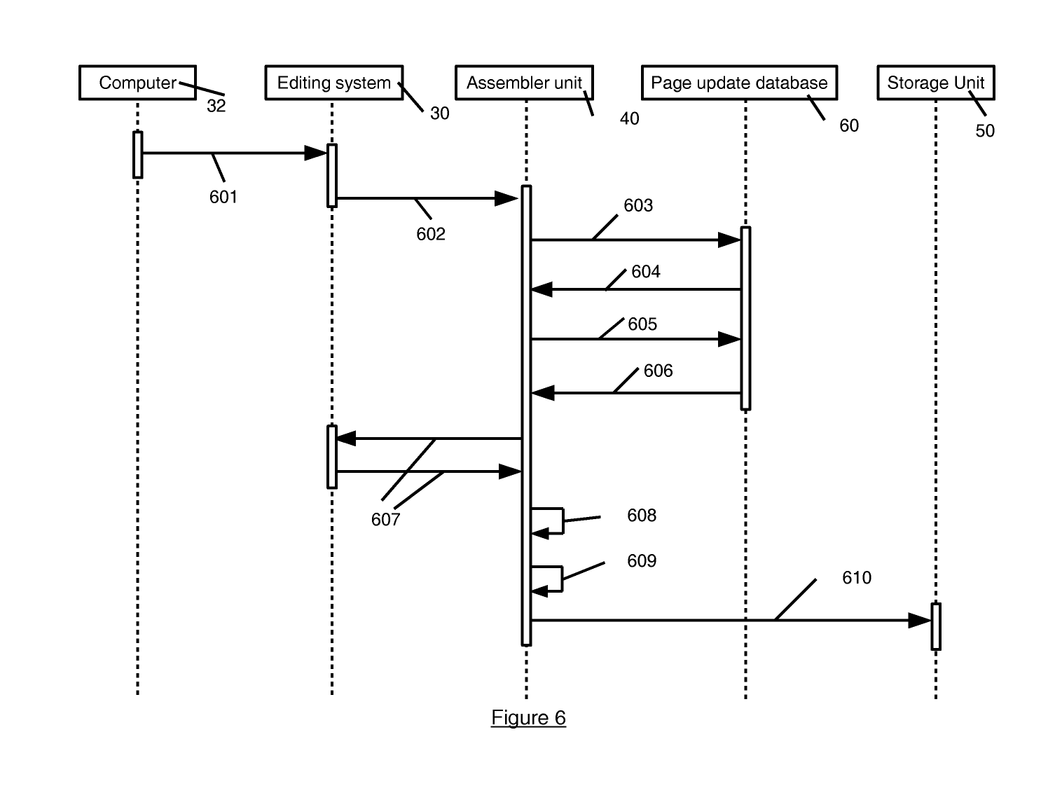

Referring to FIGS. 1 and 5, in an embodiment, each one of the processor-based devices 20 also includes a communication module 22. The communication module 22 is configured to manage communications with the storage unit 50 in order to receive the latest version of a compiled file of a page from the storage unit 50. Each one of the processor-based devices 20 also includes a display 24 for displaying the updated page upon receiving the updated compiled file for that page from the storage unit 50. The processor-based devices 20 also have memory 26 for storing assets of at least the compiled file of the page being displayed. As mentioned above, in an embodiment, displaying the updated compiled file of a page is performed through a dedicated software application running on the processor-based device 20.

In an embodiment, in order to minimise the delay between the storage unit 50 receiving the updated compiled file and transmitting it to one of the processor-based devices 20, the communication module 22 of each one of the processor-based device 20 is configured to maintain a page communication channel open (for example and without being limitative, via a long polling HTTP request) with the storage unit 50, when requesting an update of the page being displayed on its display 24. In this configuration, an updated compiled file can be sent from the storage unit 50 to the processor-based device 20 as soon as it becomes available on the storage unit 50. In other words, the processor-based device 20 will first request an update of the page it is currently displaying. If the storage unit 50 has no updated compiled file more recent than the one currently available on the processor-based device 20 when the update is requested, the page communication channel is maintained open. The storage unit 50 then waits for an updated compiled file more recent than the one currently available on the processor-based device 20 to become available. Once it does, the communication module 56 of the storage unit 50 immediately sends the updated compiled file to the corresponding processor-based device 20 over the already open page communication channel.

In an embodiment, in order to maintain the page communication channel open between the processor-based device 20 and the storage unit 50, the communication module 22 of the processor-based device 20 is configured to repetitively re-open the page communication channel whenever it closes. In some cases, for example in order to respect network constraints, the page communication channel can be closed following the transmission of an updated compiled file from the storage unit 50 to the processor-based device 20, or can be closed periodically, even if no compiled file has been transmitted. In such cases the repetitive re-opening of the page communication channel between the processor-based device 20 and the storage unit 50 allows the page communication channel to be constantly open therebetween.

In an embodiment, the communication module 22 of the processor-based device 20 and the communication module 56 of the storage unit 50 operate according to an HTTP long poll mechanism in order to establish the page communication channel and transmit updated compiled files. However, one skilled in the art will understand that, in an alternative embodiment, the communication module 22 of the processor-based device 20 and the communication module 56 of the storage unit 50 can operate according to a different mechanism, such as a network socket mechanism, a websocket mechanism, or the like, in order to establish the page communication channel and transmit updated compiled files.

The above described page updating process between a processor-based device 20 and the storage unit 50 is performed for each one of the processor-based devices 20 connected to the storage unit 50 and therefore allows the page displayed on each one of the processor-based devices 20 to be automatically updated. Such a process, combined with the above described process of compiling pages edited on the editing system 30, therefore allows a user to automatically display on processor-based devices 20 a version of a page edited on the editing system 30.

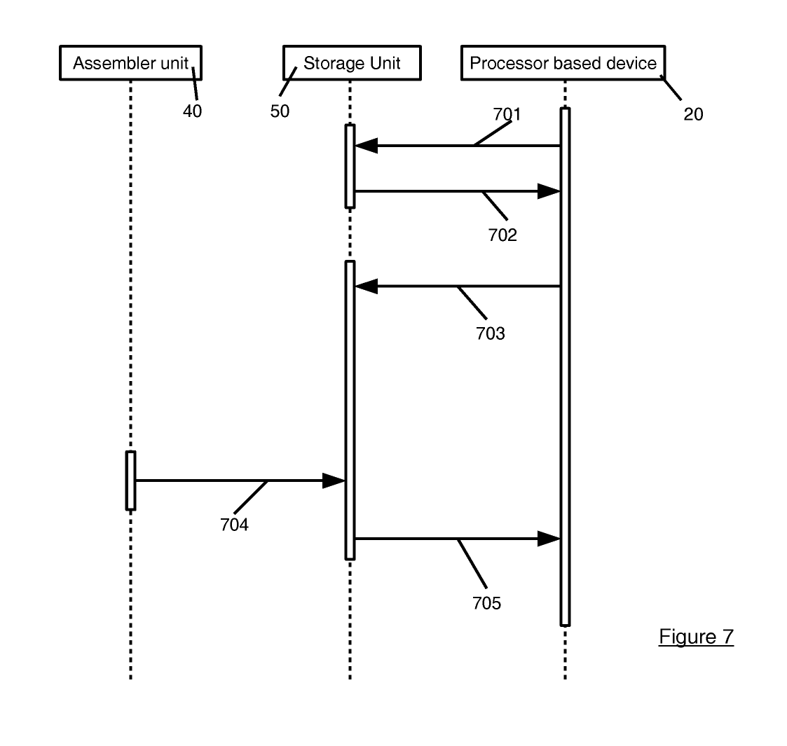

Referring to FIG. 7, a sequence of operation for the transmission of updated compiled files from the storage unit 50 to one of the processor-based devices 20, according to an exemplary embodiment, is shown. One skilled in the art will understand that, in an embodiment, such a sequence of operation is performed simultaneously for each one of the processor-based devices 20 communicating with the storage unit 50.

In the exemplary embodiment of FIG. 7, a user selects page 0x01 for display on the processor-based device 20, but no compiled file corresponding to page 0x01 is initially stored in the memory of the processor-based device 20. At step 701, the communication module of the processor-based device 20 requests a compiled file for page 0x01 from the storage unit 50, and opens a page communication channel therebetween. At step 702, the storage unit 50 immediately responds with the most recent updated compiled file available for page 0x01, and the page communication channel is then closed. One skilled in the art will understand that steps 701 and 702 can be omitted in an alternative embodiment where a compiled file corresponding to page 0x01 is initially stored in the memory of the processor-based device 20. At step 703, the communication module of the processor-based device 20 requests an update of page 0x01 from the storage unit 50 and opens a page communication channel therebetween. Given that no updated compiled file more recent than the one currently stored on the processor-based device 20 for page 0x01 is available on the storage unit 50, the page communication channel is left open. At step 704, a new updated compiled file is received by the input module of the storage unit 50 from the output module of the assembler unit 40. At step 705, the storage unit 50 transmits the updated compiled file for page 0x01 received at step 704 to the processor-based device 20 over the page communication channel, and the page communication channel is then closed. One skilled in the art will understand that steps 703 to 705 are continuously repeated during the period of time while page 0x01 is displayed on the processor-based device 20.

In an embodiment, and as can be seen better in FIG. 2b, the assets associated with a page of the edition are not directly included into the compiled file of that page. Each compiled file rather includes a reference to its associated assets (labelled ID2 to IDn in FIG. 2b) in order to include those assets in the page and display them inside the page as the page is being displayed. Therefore, in order to allow the processor-based device 20 to properly display the content of a page, including its associated assets, the assets of a page of the edition also have to be transmitted to the processor-based device 20. As mentioned above, once an asset has been received by the processor-based device 20, it is stored in its memory and can be used for any version of the updated compiled file displayed by the processor-based device 20 which uses the same asset.

Referring to FIGS. 1, 3, 4 and 6, in an embodiment, each one of the assets is sent from the editing system 30 and received by the input module 42 of the assembler unit 40. The assets are then transformed (or formatted) appropriately by the asset transformation module 45 of the assembler unit 40. Each asset is subsequently transmitted to the storage unit 50 for subsequent transfer to the corresponding ones of the processor-based devices 20 which uses the asset. One skilled in the art will understand that, in an embodiment, the transformation of each one of the assets can be performed by a dedicated module of the system 10, or the like, or any other component connected to the system 10 and configured to transform the assets, rather than by the asset transformation module 45 of the assembler unit 40.

Referring again to FIGS. 1 and 5, in an embodiment, the communication module 22 of each processor-based device 20 is further configured to request assets associated with the updated compiled file from the storage unit 50, when those assets are not stored in the memory 26 of the processor-based device 20.

In an embodiment, in order to prevent errors caused by a processor-based device 20 requesting an asset which has not yet been received by the storage unit 50, for example due to an asset transformation delay (i.e. a delay resulting from a transformation such as, without being limitative, resizing, cropping, compressing, and/or changing the format of the asset, or the like), and in order minimise the delay between receiving assets on the storage unit 50 and transmitting them to a processor-based device 20, the communication module 22 of each one of the processor-based devices 20 is configured to request assets from the storage unit 50 and to maintain open an asset communication channel (for example and without being limitative via a long polling HTTP request) between the processor-based device 20 and the storage unit 50. In this configuration, an asset can be sent from the storage unit 50 to the processor-based device 20 as soon as it becomes available on the storage unit 50. For example, an image can be sent from the storage unit 50 to the processor-based device 20 as soon as it becomes available on the storage unit 50 following being resized and/or cropped by the asset transformation module 45.

In an embodiment, the asset communication channel is kept open by the communication module 22 of the processor-based device 20 for a maximum of a predetermined time interval, such as and without being limited to between about 10 seconds and about 20 seconds. If an asset has not been transmitted by the end of the predetermined time interval, the connection times out and an error message is sent to the processor-based device 20 from the storage unit 50. In an embodiment, the predetermined time interval during which the asset communication channel is left open substantially corresponds to a maximum time interval which is normally required for an asset to be formatted and transmitted to the storage unit 50. Hence, if the predetermined time interval is reached, the probability that an error occurred, for example during the asset transformation, are high. In other words, if the asset requested by the processor-based device 20 is not available on the storage unit 50 when the asset is requested, the asset communication channel is left open for the maximum of the predetermined time interval such that the storage unit 50 can wait for the asset to become available. If the asset becomes available, the communication module of the storage unit 50 immediately sends the updated compiled file to the requesting processor-based device 20 through the asset communication channel.

One skilled in the art will understand that each one of the processor-based devices 20 may simultaneously open and maintain a plurality of asset communication channels with the storage unit 50, with each one of the plurality of asset communication channels being for a specific asset. Moreover, a plurality of processor-based devices 20 can simultaneously request the assets corresponding to the page which they are currently displaying and which they do not already have stored in their memory.

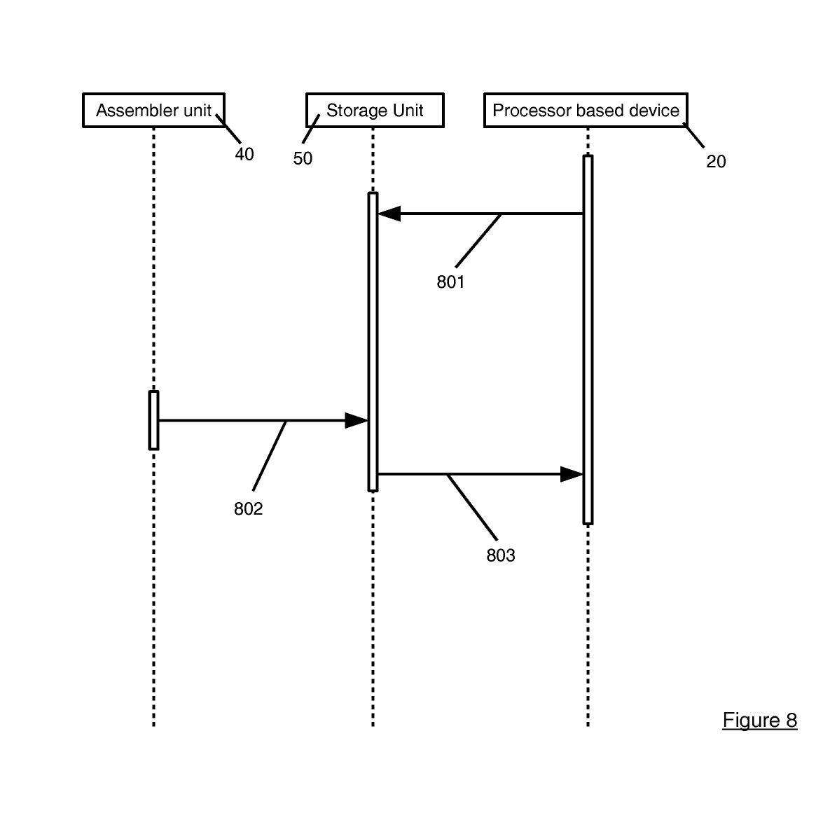

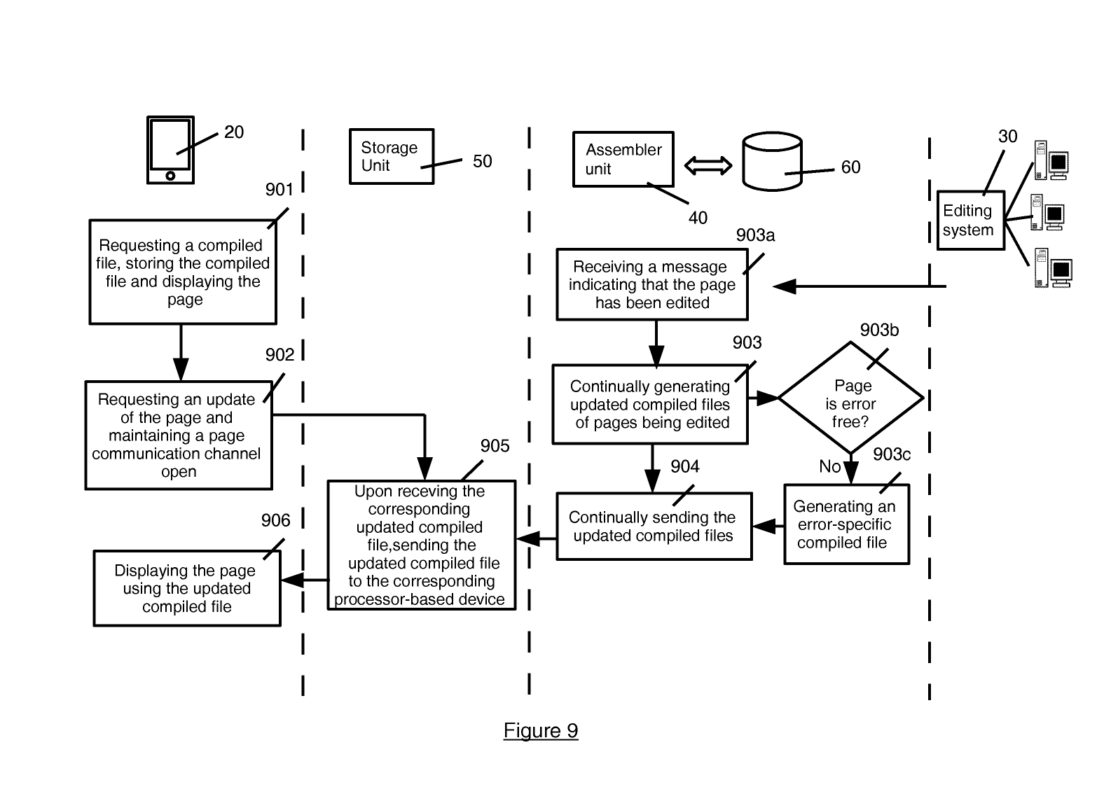

Referring to FIG. 8, a sequence of operation for the transmission of an asset from the storage unit 50 to one of the processor-based devices 20, according to an exemplary embodiment, is shown. One skilled in the art will understand that, in an embodiment, such a sequence of operation is performed simultaneously for each asset to be transferred from the storage unit 50 to a corresponding one of the processor-based devices 20 communicating with the storage unit 50.

In the exemplary embodiment of FIG. 8, at step 801, the communication module of the processor-based device 20 requests asset IDx from the storage unit 50, and opens an asset communication channel therebetween. Given that asset IDx is not available on the storage unit 50, the asset communication is left open. At step 802, asset IDx is received by the input module of the storage unit 50 from the output module of the assembler unit 40. At step 803 the storage unit 50 transmits asset IDx to the processor-based device 20 over the asset communication channel and the asset communication channel is then closed.

A system for automatically displaying pages of a digital edition on a processor-based device while at least some of the pages are concurrently being edited on computers connected to the editing system has been described above. A computer implemented method for automatically displaying pages of a compiled digital edition on processor-based devices, while at least some of the pages are concurrently being edited on computers connected to an editing system, will now be described.

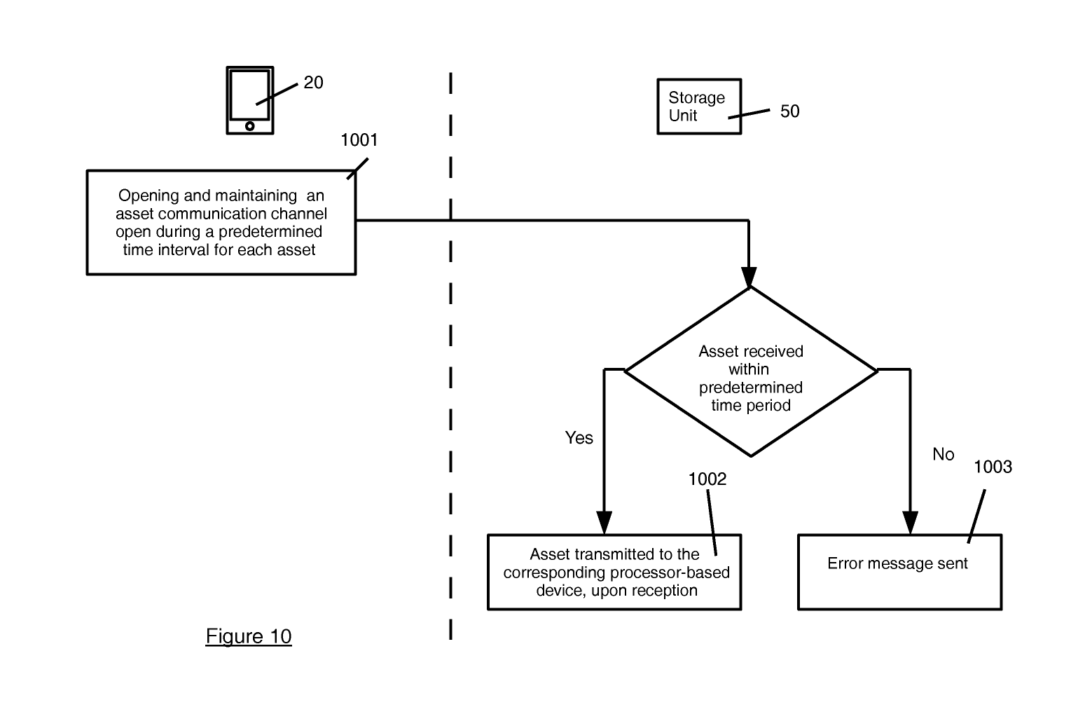

Referring to FIG. 9, in an embodiment of the method, at least one processor-based device requests an update for a given page of a digital edition, i.e. requests an updated compiled file more recent than the compiled file currently available on the processor-based device, and maintains a page communication channel open between the processor-based device and the storage unit (Step 902). The assembler unit continually generates updated compiled files of the pages of the edition being edited on computers connected to the editing system (Step 903). In an alternative embodiment, at step 903, the assembler unit can continually generate updated compiled files solely for the pages of the edition being edited and for which an update has been requested by a processor-based device. The assembler unit continually sends the updated compiled files to the storage unit to be stored in a memory thereof (Step 904). For each one of the pages for which the processor-based device has requested an update, the storage unit sends the corresponding updated compiled file over the page communication channel, as soon as that compiled file is received by the storage unit (Step 905). The processor-based device subsequently displays the corresponding updated compiled file of the page on its display (Step 906).

One skilled in the art will understand that, in an alternative embodiment, the assembler unit can generate updated compiled files for all pages of the edition sequentially.

In an embodiment, the step of requesting an update for a given page of the digital edition and maintaining a page communication channel between the processor based device and the storage unit (step 902) is repeated continually upon closure of the page communication channel in order to maintain the page communication channel in an open state.

Referring to FIG. 10, in an embodiment, each one of the processor-based devices also downloads from the storage unit the assets associated with the updated compiled file corresponding to the page of the digital edition received by the processor-based device and which are not already stored in the processor-based device's memory. In an embodiment, the above-described downloading of the assets includes the steps of opening and maintaining an asset communication channel for each one of the assets to be downloaded from the storage unit, during a maximum of a predetermined time interval, (step 1001) in order to receive a corresponding asset when it becomes available on the storage unit (step 1002). If the asset is not received during the predetermined time interval, its corresponding asset communication channel is closed and an error message is sent by the storage device to the processor-based device (step 1003).

Turning again to FIG. 9, in an embodiment, the method includes an initial step of each processor-based device requesting from the storage device a compiled file of a page to be displayed. The processor-based device stores the page and displays it (Step 901). In an embodiment, the compiled file is the most recent version of the page at the time when the request is made. This initial step allows the processor-based device to initially store and display a compiled file for the page and subsequently perform the additional steps of the method which are intended to generate and transmit compiled files of subsequent versions of the page to the processor-based device for storage and display, as those versions are created by users modifying the page on the editing system.

One skilled in the art will understand that, if an updated compiled file more recent than the compiled file currently available on the processor-based device is available on the storage unit at the time the initial request is made by the processor-based device, the corresponding updated compiled file will be immediately sent by the storage unit to the processor-based device over the page communication channel. In an embodiment, the processor-based device immediately proceeds with a new request for an update of the page and maintains the page communication channel open between the processor-based device and the storage unit.

In an embodiment, the step of continually generating updated compiled files of at least the pages being edited on computers connected to the editing system (Step 903) includes a sub-step of receiving a message from the editing system indicating that the page has been edited by a user on the editing system (Step 903a). The message is received by the assembler unit and is used to identify the pages which have been edited and which therefore require a compilation. In an embodiment, step 903 further includes a sub-step of, prior to the compilation of each page, determining whether the page is an error-free or an error-generating page (Step 903b). If the page is an error-generating page, an error-specific compiled file is generated (step 903c).

As can be appreciated, the entire digital edition does not need to be compiled each time a given page needs to be displayed. In addition to allowing each page of the edition to be compiled individually, the system of the present invention is also configured to detect that changes have been made to a page on one of the user's computer and that the page must be compiled and sent to a specific processor-based device for display. A user modifying a page of a digital edition on his computer can thus automatically and simultaneously display the changes on one or more processor-based devices (typically electronic tablets) to validate whether the layout is satisfactory, without having to manually request the compilation of the page he is working on. Moreover, the present system allows several users to concurrently display the pages which they are individually editing. Each user can display the edits on a single processor-based device (for example, an iPad™ tablet) or on more than one processor-based devices (for example, an iPad™ tablet and an Android™ based tablet, such as a Samsung Galaxy™ tablet). The system and method of the present invention is thus especially advantageous when used in the context of periodic digital newspapers and magazines, since it reduces delays in the preparation of the digital editions. Moreover, the system and method of the present invention allow concurrent displaying a given page of the edition on different types of processor based devices, in order to simultaneously validate that the layout of the page is satisfactory on each type of processor based device.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A preview system for automatically previewing pages of a digital edition while at least some of the pages are concurrently being edited on computers connected to an editing system for publishing to different types of end-user devices, the preview system comprising:
a plurality of processor-based devices each corresponding to a specific type of the end-user devices, each processor-based device having a communication module configured to request an update of a given page of the digital edition and to maintain a page communication channel open between the corresponding one of the processor-based devices and a storage unit, each one of the processor-based devices running a dedicated software application for reading a compiled file containing at least the given page of the digital edition and having a display for displaying the update of the given page upon receiving an updated compiled file;
an assembler unit operatively connected to the editing system, the assembler unit comprising a compiler module configured to continually generate updated compiled files of edited pages of the digital edition in a format readable by the dedicated software application, automatically as the pages are being edited on the computers connected to the editing system, the assembler unit comprising an output module to continually send the updated compiled files to the storage unit; and
the storage unit operatively connected to the processor-based devices and to the assembler unit, the storage unit having a memory configured to store the updated compiled files, and a communication module configured to send, over the page communication channel established with a given one of the processor-based devices, the updated compiled file corresponding to the given page for which the given one of the processor-based devices has requested an update, as the updated compiled file is being received on the storage unit.

2. The system of claim 1, wherein each of the plurality of processor-based devices is distinct from the editing system and wherein the plurality of processor-based devices includes at least two electronic tablets having different display screen sizes.

3. The system of claim 1, wherein the compiler module is configured to continually generate updated compiled files of edited pages of the digital edition as they are being edited on the computers connected to the editing system, whereby changes made to one of the pages of the digital edition are automatically displayed on at least one of the plurality of processor-based devices.

4. The system of claim 1, wherein for each one of the processor-based devices, the communication module is configured to repetitively re-establish the page communication channel with the storage unit, upon closure of the page communication channel.

5. The system of claim 1, wherein the processor-based devices and the storage unit comprise a mechanism for establishing the page communication channel and sending the updated compiled file, the mechanism including one of a network socket mechanism, a websocket mechanism and an HTTP long poll mechanism.

6. The system of claim 1, wherein the compiler module comprises a parser configured to determine whether the edited pages are error-free or error-generating pages, the compiler module generating error-specific updated compiled files if the edited pages are error-generating pages.

7. The system of claim 1, further comprising a page update database connected to the assembler unit, the page update database being configured to store a new compilation request including page identification data and a compilation status for each of the edited pages.

8. The system of claim 7, wherein the assembler unit is in communication with the page update database, the assembler unit being configured to, for each successive compilation request, fetch page data relating to the edited page corresponding to the identification data stored in the compilation request, compile the page data of the corresponding edited page through the compiler module, and delete the compilation request.

9. The system of claim 8, wherein the assembler unit is configured not to store a new compilation request in the page update database for one of the edited pages if a compilation request containing page identification relating to the page is already stored in the page update database and the page is not currently being compiled.

10. The system of claim 1, wherein the assembler unit is further configured to receive messages indicative that one of the pages of the edition has been edited on the editing system.

11. The system of claim 1, wherein the processor-based devices each have a respective memory, and for each one of the processor-based devices, the memory is configured to store assets associated with the given page, and the communication module is configured to request, from the storage unit, assets associated with the updated compiled file for the given page which are not stored in its memory.

12. The system of claim 11, wherein the communication module of each one of the processor-based devices is configured to send a request for each one of the assets associated with the updated compiled file for the given page which is not stored in its memory and to maintain an asset communication channel open during a maximum of a predetermined time interval to receive a corresponding one of the assets when it is available from the storage unit.

13. A computer implemented method for automatically previewing pages of a digital edition while at least some of the pages are concurrently being edited on computers connected to an editing system for publishing to different types of end-user devices, the method comprising the steps of:
a) requesting, by at least a given one of a plurality of processor-based devices corresponding to the different types of end-user devices, an update for a given page of the digital edition and maintaining a page communication channel open between at least the given one of the processor-based devices and a storage unit;
b) continually generating, on an assembler unit, updated compiled files of pages of the edition being edited on the computers connected to the editing system in a format readable by a dedicated software application running on the processor-based devices, and continually sending the updated compiled files for storing on the storage unit;
c) sending, by the storage unit, over the page communication channel, the updated compiled file corresponding to the given page for which the given one of the processor-based devices has requested an update as the updated compiled file is being received on the storage unit; and
d) reading the updated compiled file using the dedicated software application running on the given one of the processor-based devices, and displaying the update of the given page on the given one of the processor-based devices.

14. The computer implemented method of claim 13, wherein step b) comprises continually generating, on the assembler unit, updated compiled files of pages of the edition being edited on the computers connected to the editing system as the pages of the edition are being edited, whereby changes made to one of the pages of the digital edition are automatically displayed on at least one of the plurality of processor-based devices.

15. The computer implemented method of claim 13, wherein step a) is continually repeated upon closure of the page communication channel.

16. The computer implemented method of claim 13, wherein step b) comprises receiving a message from the editing system indicating that the page has been edited.

17. The computer implemented method of claim 13, comprising a step performed prior to step a), of requesting by the given one of the processor-based devices a compiled file of the given page, storing the compiled file on the given one of the processor-based devices and displaying the page.

18. The computer implemented method of claim 13, wherein steps a) and c) are performed using one of a network socket mechanism, a websocket mechanism and an HTTP long poll mechanism.

19. The computer implemented method of claim 13, wherein step b) further comprises the step of, for each one of at least the pages of the edition being edited on the computers connected to the editing system, determining whether the page is an error-free or an error-generating page and generating an error-specific compiled file if the page is an error-generating page.

20. The computer implemented method of claim 13, wherein step b) comprises scheduling a compilation of one of the edited pages only if no compilation of the page has already been scheduled or if the page is currently being compiled and no subsequent compilation of the page has already been scheduled.

21. The computer implemented method of claim 13, comprising a step of downloading from the storage unit, by the given one of the processor-based devices, assets associated with the updated compiled file corresponding to the given page of the digital edition which are not already stored in a memory of the given one of the processor-based devices.

22. The computer implemented method of claim 21, wherein the step of downloading assets comprises maintaining an asset communication channel open during a maximum of a predetermined time interval, to receive a corresponding one of the assets when it is available from the storage unit.
